(19) United States
(12) Patent Application Publication
(10) Pub. No.: US 2012/0064869 A1
(43) Pub. Date: Mar. 15, 2012

(54) SYSTEM AND METHOD FOR INCORPORATING AUDIO CONTENT IN INTERNET COMMUNICATIONS

(76) Inventor: Michael A. Sharp, Porter, TX (US)

(21) Appl. No.: 13/321,359

(22) PCT Filed: May 21, 2010
(86) PCT No.: PCT/US10/35838

§ 371 Date: Nov. 18, 2011

Related U.S. Application Data
(60) Provisional application No. 61/180,689, filed on May 22, 2009.

(51) Int. Cl. G06F 15/16; H04W 4/00

(52) U.S. Cl. 455/414.1; 709/206

(57) ABSTRACT

A disclosed method for incorporating audio content in an Internet communication includes assigning a phone number to the audio content, incorporating the phone number in the communication, and providing the communication to a recipient. The audio content may be a recorded audio message. The communication may be a post or status update on a blogging service, or a post to a Web page. The phone number may be automatically dialed when a recipient of the communication selects the phone number. The method may also include receiving a telephone call from the recipient and directed to the phone number, and providing the audio content to the recipient in response to the received telephone call. Two network servers are described, each including a memory that stores communication software, and a processor to execute the communication software. The communication software configures each processor to carry out steps of the disclosed method.

### CROSS-REFERENCE TO RELATED APPLICATIONS

This application claims the benefit of U.S. Provisional Patent Application No. 61/180,689 filed May 22, 2009, the entire disclosure of which is hereby incorporated herein by reference.

### BACKGROUND

Social network services are currently used by millions of people, and are becoming more and more popular. Most social network services are Internet based, and provide a variety of ways for users to communicate, including electronic mail (e-mail), instant messaging, and/or micro-blogging. A typical social network service focuses on building online communities of people who share interests and/or activities, or who are interested in exploring the interests and activities of others. Popular social network services include Facebook, MySpace, Twitter, and LinkedIn.

A Weblog or “blog” is electronic information provided or maintained by an individual or group. Blogs can comprise regular entries of commentary, descriptions of events, opinions, information, or other expressions of ideas, feelings, or actions. Blogs can be text only or they can include other mediums of communication, such as audio, video, or graphical depictions or images. “Blogging” is the act of providing the electronic information of a blog. Blog entries are commonly displayed in reverse-chronological order. Micro-blogging is a combination of blogging and instant messaging that allows users to create short messages that are posted to their profiles, and may be broadcast to others.

The social network service Twitter promotes micro-blogging, and delivers messages to communications devices connected to the Internet, including personal computers running World Wide Web (“Web”) browser programs, and cellular telephones (“cell phones” or “mobile phones”) with Internet access. Twitter allows members to broadcast short messages called “tweets” to their subscribers that contain no more than 140 textual characters. Micro-blogging via Twitter allows groups of people to easily stay in frequent contact with each other. Many people enjoy the resulting feeling of being “connected” with others while engaged in their normal daily activities.

One problem with using a social network service such as Twitter via an Internet-connected cell phone is that most cell phones come with very small keyboards having tiny keys intended to be activated by a user's fingers or thumbs. Sending frequent text messages with such keyboards can quickly lead to finger or thumb fatigue. Accordingly, it would be desirable to provide a system that allows blog entries to be uploaded and/or delivered more easily and/or without requiring significant text entry with a keyboard. In addition, it would be desirable to provide a system that allows audio content to be provided to a system for storing or delivering that content to others, such as via a social networking site.

### SUMMARY

A disclosed method for incorporating audio content in an Internet communication includes assigning a phone number to the audio content, incorporating the phone number in the Internet communication, and providing the Internet communication to a recipient. The audio content can be created, delivered, and/or otherwise uploaded by a user. The audio content may be a recorded audio message such as a voice message. The Internet communication may be a post or status update on a blogging service, or a post to a Web page. The phone number may be assigned to a telephony server coupled to the Internet. The phone number can be automatically dialed when a recipient of the Internet communication selects the phone number. In some embodiments, the user can be registered with the system prior to providing the audio content.

The phone number may be incorporated in the Internet communication as a link that can be activated by touching a corresponding region of a touch-sensitive display screen. The method may also include receiving a telephone call from the recipient and directed to the phone number, and providing the audio content to the recipient in response to the received telephone call. The providing of the audio content may include playing back a recorded audio message to the recipient. The providing of the audio content may be carried out via the public switched telephone network. One described network server includes a memory that stores communication software, and a processor coupled to the memory to execute the communication software. The communication software configures the processor to assign a phone number to audio content, to incorporate the phone number in an Internet communication, to provide the Internet communication to a network server, to receive a telephone call directed to the phone number, and to provide the audio content in response to the received telephone call.

Another disclosed network server includes a memory that stores communication software, and a processor coupled to the memory to execute the communication software. The communication software configures the processor to receive an Internet communication including a phone number assigned to audio content, and to provide the Internet communication to a recipient.

In certain embodiments, one or more computer-readable storage media can store computer-readable instructions for causing a computer to perform the methods described above. The novel systems and methods described herein provide many advantages over conventional systems. For example, the systems and methods disclosed herein allow a user to easily deliver audio content to a system and direct the distribution and/or storage of that information so that it can be readily accessed by the user and/or other persons.

The foregoing and other features and advantages of the disclosed embodiments will become more apparent from the following detailed description, which proceeds with reference to the accompanying figures.

### BRIEF DESCRIPTION OF THE DRAWINGS

FIG. 1 is a diagram of one embodiment of a system for incorporating audio content in Internet communications;

FIG. 2 is a diagram of an illustrative network server; and

FIG. 3 is a flowchart of one embodiment of a method for incorporating audio content in an Internet communication.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and subcombinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provides” and “achieves” to describe the disclosed methods. These terms are high-level abstractions of the actual operations that are performed. The actual operations that correspond to these terms may vary depending on the particular implementation and are readily discernible by one of ordinary skill in the art.

The social networking site Twitter allows users to include links to audio files in their messages or “tweets.” The ability to include links to audio files in tweets is advantageous for those that, for example, need to stay focused on a particular activity, those suffering from finger or thumb injury or fatigue, and those that wish to send messages that would include more than 140 characters.

The World Wide Web (“Web”) is a system of interlinked hypertext documents accessed via the Internet. The HyperText Markup Language (HTML) is the predominant markup language for Web pages, and almost all Web browsers process HTML. With Web browser software, one can view Web pages that may contain text, images, videos, and other multimedia objects, and navigate between them using hyperlinks.

A hyperlink or “link” is text or an image, displayed on a display screen, with a reference to another electronic document or file. When a user of a communication device selects a link, communication software (e.g., Web browser software) typically downloads the corresponding document or file, and automatically displays the corresponding document or file.

In devices with graphical user interfaces, a region of the display screen around a link is typically associated with the link. The user can select a link using a pointing device, such as a mouse, by selecting the corresponding region of the display screen. The user may also select a link by touching the corresponding region on a touch-sensitive display screen.

For example, suppose that a link in a Web page references an audio file. When the user selects the link, the communication software (e.g., Web browser software) expectedly downloads the audio file, and launches a player program that automatically starts playing the audio file. As the player program plays the audio file, the user hears audio information present in the audio file.

Many modern cell phones with touch-sensitive display screens allow phone numbers to be included in messages as links. When a user selects the link by touching the corresponding region of the display screen, communication software running on the cell phone automatically dials the indicated phone number. The following systems and methods provide a novel and unique system for providing and/or maintaining various information systems, such as blogs, that comprise audio content created and/or uploaded by a user.

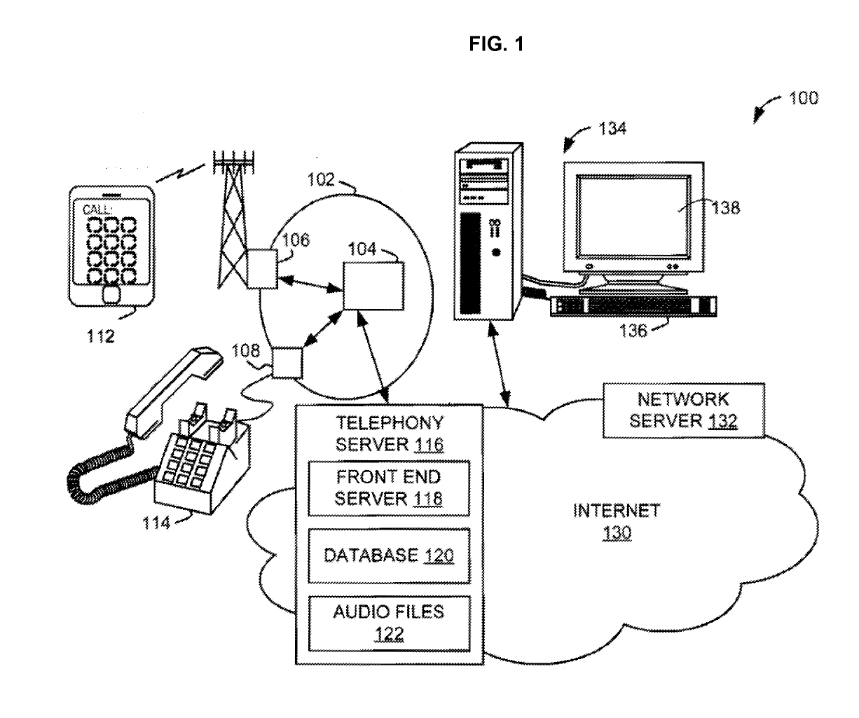

FIG. 1 is a diagram of one embodiment of a system 100 for incorporating audio content in Internet communications. In the embodiment of FIG. 1, the system 100 can include cell phones 112, a telephony server 116, a network server 132, and computer systems 134, all coupled to the Internet 130. In FIG. 1, the public switched telephone network (PSTN) is labeled “102,” and includes a hierarchy of switches 104, 106, 108, and communication links that interconnect customer provided equipment (CPE) such as the cell phones 112, “land-line” phones 114, and modems. Thus, the Internet 130 can be accessed in one or more ways (e.g., by cell phones 112, computer system 134, and/or “land-line” phones 114) to achieve the methods disclosed herein. Other devices, whether or not currently available, that operate in similar manners and which can access the Internet to achieve the methods disclosed herein are also envisioned.

As described in more detail below, the telephony server 116 can be configured to receive audio content, link that content to a source of the audio content (e.g., the telephone number of the source of the content), store that audio content for later delivery (e.g., upon request), and/or deliver that audio content to other locations, such as an intended recipient and/or an Internet-based social networking service. In addition to or instead of audio content, the methods and systems disclosed herein can receive, link, store, and/or deliver other types of communications as well, including, for example, video content, graphical images, or text-only content. In addition, it should be understood that to the extent that other communication content includes sound (e.g., video with sound), that communication content—or at least the part that represents the audio portion—shall be considered audio content as described herein.

The methods and functions of the telephony server 116 described herein can be implemented or performed by software stored on one or more tangible computer-readable media (e.g., one or more optical media discs, volatile memory or storage components (such as DRAM or SRAM), or nonvolatile memory or storage components (such as hard drives)) and executed on one or more computing systems. The computing systems can include one or more central processing units (CPUs) and a memory, such as random access memory (RAM) for temporary storage of information and/or a read only memory (ROM) for permanent storage of information, and a mass storage device, such as a hard drive, diskette, or optical media storage device. Typically, the modules of the computing system are connected to the computer using a standards-based bus system, such as, for example, Peripheral Component Interconnect (PCI), Microchannel, SCSI, Industrial Standard Architecture (ISA) and Extended ISA (EISA) architectures.

The software for performing each of the steps described herein with regard to the telephony server 116 can be executed on a single computer or on a networked computer (e.g., via the Internet, a wide-area network, a local-area network, a client-server network, or other such network). The systems and methods disclosed herein can also be performed using cloud computing, a form of Internet-based computing, whereby shared resources, software and information are provided to computers and other devices on-demand. The software embodiments disclosed herein can be described in the general context of computer-executable instructions, such as those included in program modules, which can be executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment. For clarity, only certain selected aspects of the software-based implementations are described. Other details that are well known in the art are omitted. For example, it should be understood that the disclosed technology is not limited to any specific computer language, program, or computer.

The exemplary embodiments described herein are directed to cell phones and computer systems configured to access the Internet. However, it should be understood that various other computing systems and devices can be configured to link to the telephony server described herein, including, for example, personal digital assistants, audio or video players, personal gaming devices, etc. The telephony server 116 can be coupled to the PSTN 102 to initiate and receive phone calls. The telephony server 116 can, for example, connect to the PSTN 102 via a trunk line that supports multiple simultaneous calls. The telephony server 116 can be an Asterisk™ server (or a farm of such servers), the setup and operation of which is described in detail in J. Van Meggelen, J. Smith, and L. Madsen, Asterisk: The Future of Telephony, © 2005 O'Reilly Media, Inc., Farnham. U.S. Patent Publication No. 2008/0107102, filed Oct. 23, 2007, entitled “PHONECASTING SYSTEMS AND METHODS” also describes various telephone-based systems and methods, and is hereby incorporated herein by reference in its entirety.

In the embodiment of FIG. 1, the telephony server 116 can include a front end server 118, a database 120, and one or more audio files 122. The front end server 118 provides a Web site that serves as an interface for Internet users. Internet users typically run Web browser software on their computer systems 134. The Web browser software displays Web pages on display screens 138 of the computer systems 134. A Web page hosted by the front end server 118 may have, for example, one or more fields for users to populate via input devices, such as keyboards 136. Pointing devices such as mice may also be input devices of the computer systems 134. Users can register for the instant service that incorporates audio content in Internet communications via the front end server 118. The database 120 stores user registration information, and information about phone numbers allocated to the telephony server 116. Each of the audio files 122 can have a corresponding phone number in the database 120.

Prior to generating an Internet communication to include audio content, a registered user may provide the audio content to the telephony server 116. For example, the user may place a phone call to the telephony server 116 via a communication device (e.g., one of the cell phones 112, or one of the land line phones 114). The phone call may be directed to a phone number assigned to the user by the telephony server 116. When the telephony server 116 receives the phone call, the telephony server 116 may start recording audio content (e.g., speech produced by the user). The user may produce a signal that indicates an end of the audio content by, for example, pressing a particular key on a keypad of the communication device. When the telephony server 116 receives the signal, the telephony server 116 may stop recording the audio content, create an audio file including the audio content, and store the audio file as one of the audio files 122.

Alternately, the user may generate an audio file that includes the audio content, and provide or upload the audio file to the telephony server 116. For example, software running on a communication device (e.g., one of the cell phones 112, or one of the computer systems 134) may allow a user to record audio content, producing an audio file that contains the audio content. The software may be, for example, a Web browser plug-in. The software, or the user, may then provide or upload the audio file to the telephony server 116.

When the telephony server 116 produces, or receives, the audio file containing the audio content, the telephony server 116 may assign a unique token (e.g., alphanumeric code or other unique identifier) to the audio file, provide the token to the user, and store the token in the database 120 along with information that indicates that the token corresponds to the audio file (e.g., an address of, or pointer to, the audio file in the audio files 122). The telephony server may access the database 120, obtain an available phone number, assign the available phone number to the audio file, store information in the database 120 that indicates that the phone number is no longer available, and store information in the database 120 that indicates that the phone number corresponds to the audio file.

When the user generates the Internet communication, the user may include in the Internet communication the unique token (e.g., alphanumeric code) received from the telephony server 116. The position of the token in the Internet communication may indicate the position where a link to the audio content is to appear. Software running on a communication device being used by the user may then send the Internet communication to the telephony server 116. The communication device may be, for example, one of the cell phones 112, or one of the computer systems 134.

When the telephony server 116 receives the Internet communication, the telephony server 116 may parse the Internet communication, find the unique token, and access the database 120 to determine the phone number corresponding to the token. The telephony server 116 may then substitute the phone number for the token in the Internet communication, thereby incorporating the phone number corresponding to the audio content in the Internet communication. The telephony server 116 can be coupled to the network server 132 via a network, which can comprise, for example, a wide-area network, a local-area network, a client-server network, the Internet, or other such network. The telephony server 116 can provide the Internet communication, including the phone number, to the network server 132 via the network (e.g., Internet 118).

The Internet communication may be, for example, a post or status update on a blogging service hosted by the network server 132. In this situation, the network server 132 may provide the Internet communication to one or more recipients. Alternately, the Internet communication may be an update to a Web page hosted by the network server 132. In this situation, the network server 132 may post the update to the Web page.

The telephony server 116 may incorporate the phone number corresponding to the one of the audio files 122 in the Internet communication as a link that can be selected by a recipient of the Internet communication. For example, in a communication device with a graphical user interface or a touch-sensitive display screen, a region of the display screen (e.g., of one of the cell phones 112 or one of the display screens 138) around the link may be associated with the link. The user may be able to select a link by using a pointing device, such as a mouse, or by touching the corresponding region of a touch-sensitive display screen.

As described above, many modern cell phones with touch-sensitive display screens allow phone numbers to be included in messages as links. When the user selects the link by touching the corresponding region of the display screen, communication software running on the cell phone expectedly automatically dials the indicated phone number.

For example, the iPhone is an Internet-capable cell phone manufactured by Apple, Inc. The iPhone uses the Uniform Resource Identifier (URI) scheme “tel” to specify telephone numbers. For example, HyperText Markup Language (HTML) code to make the phone number “1-800-694-7466” for Apple iPhone technical support in the United States a link is: <a href=“tel:+1-800-694-7466″>1-800-694-7466</a>. When displayed on a display screen of an iPhone, the phone number “1-800-694-7466” becomes a link, and selecting the link causes communication software running on the iPhone to dial the phone number 1-800-694-7466.

When the telephony server 116 receives a telephone call directed to a phone number assigned to one of the audio files 122 (e.g., from a recipient of an Internet communication), the telephony server 116 accesses the database 120 to determine the one of the audio files 122 corresponding to the phone number, invokes a player program, and identifies the one of the audio files 122 to the player program. The player program automatically plays the corresponding one of the audio files 122, thereby providing the corresponding audio content to the caller in response to the received telephone call.

In some embodiments, communication software running on a user's communication device may place a phone call to the telephony server 116. The phone call may be directed to a phone number assigned to the user by the telephony server 116. When the telephony server 116 receives the phone call, the telephony server 116 may start recording audio content (e.g., speech or other sounds produced by the user). The user may produce a signal that indicates an end of the audio content by, for example, pressing a particular key on a keypad of the communication device. When the telephony server 116 receives the signal, the telephony server 116 may stop recording the audio content, create an audio file including the audio content, and store the audio file as one of the audio files 122.

The telephony server 116 may then access the database 120, obtain an available phone number, assign the available phone number to the audio file, store information in the database 120 that indicates that the phone number is no longer available, and store information in the database 120 that indicates that the phone number corresponds to the audio file.

The telephony server 116 may then provide the phone number, corresponding to the audio file, to the communication software running on a user's communication device. The communication software running on a user's communication device may automatically embed the phone number received from the telephony server 116 in the Internet communication (e.g., a social networking message). The communication software may allow the user to edit the Internet communication, then send the communication to the network server 132. Alternatively, a fixed phone number can be pre-assigned for use with the user's social messages and the software can automatically embed that number in an editable message after the audio content has been recorded.

The network server 132 may provide the Internet communication to one or more recipients. People placing phone calls to the phone number in the Internet communication will hear a latest audio message, and may be offered an option to hear previous audio messages generated by the user.

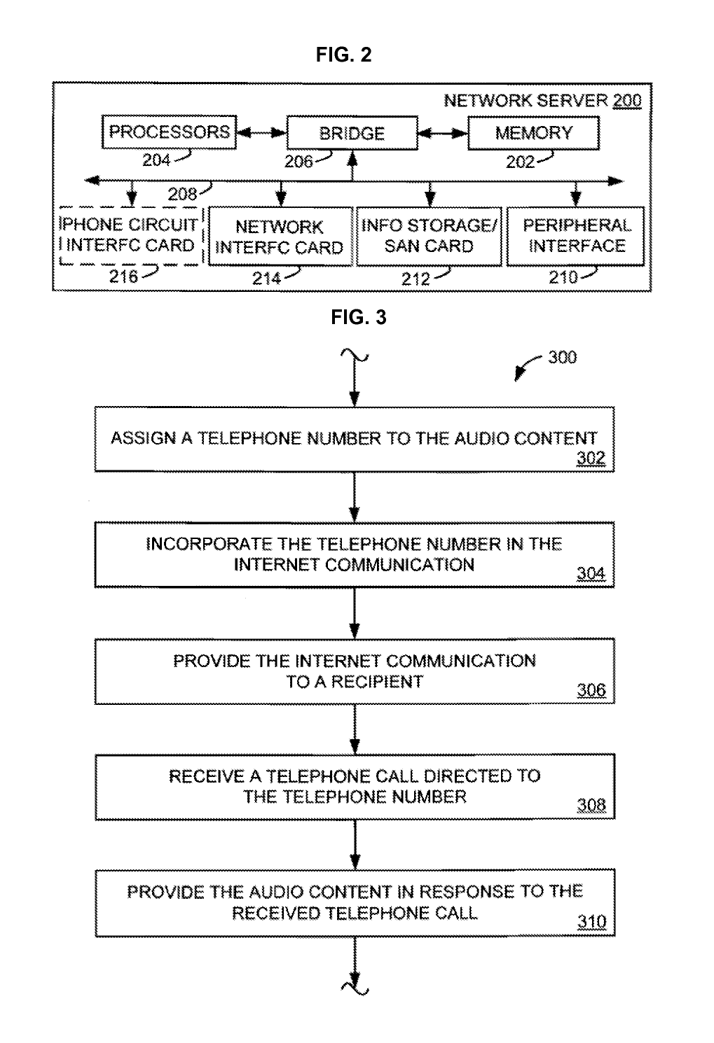

FIG. 2 is a diagram of an illustrative network server 200. The telephony server 116 and the network server 132 may include some or all of the components of the illustrative network server 200. The network server 200 can include a memory 202, one or more processors 204, and a high-speed bridge that connects the processor(s) 204 with the memory 202 and the expansion bus 208. The expansion bus 208 can support communication with a peripheral interface 210, an information storage device 212, a network interface card 214, and an optional phone circuit interface card 216.

The peripheral interface 210 can provide ports for communicating with external devices such as keyboard, mice, universal serial bus (USB) devices, printers, cameras, speakers, etc. On many servers, these ports may be left largely unused, but they are available for configuration, diagnostic, and/or performance monitoring purposes. The information storage device 212 is typically a nonvolatile memory for firmware and/or a hard drive for extended storage of software and data. On distributed systems with high data availability requirements, the information storage device 212 is replaced or supplemented with a storage area network (SAN) card that enables shared access to a large disk array. The network interface card 214 provides access to other network servers and usually to the Internet as a whole.

A telephone circuit interface card 216 is optionally included in the illustrative network server 200. In some embodiments of the telephony server 116, the connection to the PSTN 102 is accomplished indirectly via Voice over Internet Protocol (VoIP) techniques, eliminating the need for dedicated telephone circuit interface hardware.

Before the illustrative network server 200 boots, relevant software components and data are stored on the local hard drive 212, or sometimes on a network disk accessible via the network interface card. After the initial boot-up diagnostics are completed, the processor(s) loads the communication software components into memory, either all at once or on an “as needed” basis (e.g., by paging the needed instructions into memory). As the processor(s) execute the software instructions, the software configures the operation of the illustrative server(s) in accordance with the methods and principles set forth herein.

As discussed above, the telephony server 116 can be a network server that includes a memory storing communication software, and a processor coupled to the memory to execute the communication software. The communication software configures the processor to assign a phone number to audio content, to incorporate the phone number in an Internet communication, to provide the Internet communication to a network server, to receive a telephone call directed to the phone number, and to provide the audio content in response to the received telephone call.

The network server 132 includes a memory that stores communication software, and a processor coupled to the memory to execute the communication software. The communication software configures the processor to receive an Internet communication including a phone number assigned to audio content, and to provide the Internet communication to one or more recipients.

FIG. 3 is a flowchart of one embodiment of a method 300 for incorporating audio content in an Internet communication. During a first step 302 of the method 300, a phone number is assigned to the audio content. The phone number is incorporated in the Internet communication during a step 304. During a step 306, the Internet communication is provided to a recipient. A telephone call directed to the phone number is received during a step 308. During a step 310, the audio content is provided in response to the received telephone call.

In view of the many possible embodiments to which the disclosed principles may be applied, it should be recognized that the illustrated embodiments are only preferred examples and should not be taken as limiting in scope. Rather, the scope of protection is defined by the following claims. I therefore claim all that comes within the scope and spirit of these claims.

What is claimed is:

1. A method for incorporating audio content in an Internet communication, the method comprising:
receiving information comprising audio content;
assigning a telephone number to the audio content;
incorporating the telephone number in the Internet communication; and
providing the Internet communication to a recipient.

2. The method as recited in claim 1, wherein the audio content is a recorded audio message.

3. The method as recited in claim 2, wherein the recorded audio message is a voice message.

4. The method as recited in claim 1, wherein the Internet communication is a post or status update on a blogging service.

5. The method as recited in claim 1, wherein the Internet communication is a post to a World Wide Web page.

6. The method as recited in claim 1, wherein the telephone number is assigned to a telephony server coupled to the Internet.

7. The method as recited in claim 1, wherein the telephone number can be automatically dialed when a recipient of the Internet communication selects the telephone number.

8. The method as recited in claim 1, wherein the telephone number is incorporated in the Internet communication as a link that can be activated by touching a corresponding region of a touch-sensitive display screen.

9. The method as recited in claim 1, further comprising:
receiving a telephone call from the recipient and directed to the telephone number; and
providing the audio content to the recipient in response to the received telephone call.

10. The method as recited in claim 9, wherein the providing of the audio content comprises playing back a recorded audio message to the recipient.

11. The method as recited in claim 9, wherein the providing of the audio content is carried out via the public switched telephone network.

12. A method for incorporating audio content in an Internet communication, the method comprising:
receiving information comprising audio content;
assigning a telephone number to the audio content;
incorporating the telephone number in the Internet communication;
providing the Internet communication to a recipient;
receiving a telephone call directed to the telephone number; and
providing the audio content in response to the received telephone call.

13. A network server, comprising:
a memory that stores communication software; and
a processor coupled to the memory to execute the communication software,
wherein the communication software configures the processor to assign a telephone number to audio content, to incorporate the telephone number in an Internet communication, to provide the Internet communication to a network server, to receive a telephone call directed to the telephone number, and to provide the audio content in response to the received telephone call.

14. The network server as recited in claim 13, wherein the audio content is a recorded audio message.

15. The network server as recited in claim 13, wherein the Internet communication is a post or status update on a blogging service.

16. The network server as recited in claim 13, wherein the Internet communication is a post to a Web page.

17. The network server as recited in claim 13, wherein the telephone number can be automatically dialed when a recipient of the Internet communication selects the telephone number.

18. A network server, comprising:
a memory that stores communication software; and
a processor coupled to the memory to execute the communication software,
wherein the communication software configures the processor to receive an Internet communication including a telephone number assigned to audio content, and to provide the Internet communication to a recipient.

19. The network server as recited in claim 18, wherein the audio content is a recorded audio message.

20. The network server as recited in claim 18, wherein the Internet communication is a post or status update on a blogging service.
